(19) United States
(12) Patent Application Publication
(10) Pub. No.: US 2017/0088347 A1
(43) Pub. Date: Mar. 30, 2017

(54) Trash Bag Apparatus

(71) Applicant: Michael Weber, Nesconset, NY (US)

(72) Inventor: Michael Weber, Nesconset, NY (US)

(21) Appl. No.: 15/279,091

(22) Filed: Sep. 28, 2016

Related U.S. Application Data
(60) Provisional application No. 62/233,775, filed on Sep. 28, 2015.

(51) Int. Cl. B65F 1/00; B65D 33/25; B65D 75/00; B65D 33/06

(52) U.S. Cl. CPC B65F 1/002; B65F 1/0026; B65D 33/06; B65D 33/2591; B65D 75/008

(57) ABSTRACT

A trash bag apparatus for holding a variety of trash and refuse material is provided. The trash bag apparatus comprises a trash bag having an open top end and a closed bottom end. A zipper slide closure is mounted to the open top end of the trash bag with the zipper slide closure moveable across the open top end of the trash bag to releasably seal the top end closed in a leak free manner. Upon closing the zipper slide closure, the trash bag inhibits odors, liquid, and other material from escaping the trash bag thus ensuring a pleasant, odor free environment.

### CLAIM OF PRIORITY

This patent application claims priority under 35 USC 119 (e) (1) from U.S. Provisional Patent Application Ser. No. 62/233,775 filed Sep. 28, 2015, of common inventorship herewith entitled, “Zip Roc Bag,” which is incorporated herein by reference as though the same were set forth in its entirety.

### FIELD OF THE INVENTION

The present invention pertains to the field of waste management, and more specifically to the field of trash bags.

### BACKGROUND OF THE INVENTION

For many people, the daily disposal of garbage is a necessary fact of life. Empty milk jugs, food containers, clothing tags, used razor blades, orange peels, scraps of paper and soda pop bottles, are but just a few of the items tossed in the trash every day, by millions of people across the country. Because almost everyone produces garbage, the vast majority of households are equipped with at least one if not several garbage cans. Produced in a variety of sizes, garbage cans are usually found in kitchens, bathrooms, bedrooms, laundry rooms and garages, providing consumers an easy means of collecting waste.

Most people find that lining their garbage cans with disposable, plastic trash bags reduces the mess associated with waste collection. Trash bags are particularly useful because they keep the interior of the garbage can clean and free of debris. This is especially important in the kitchen where discarded leftovers, table scraps and other bits of food quickly grow moldy and emit a foul odor when left to collect in the bottom of a trash can.

Although trash bags are a necessary and practical item, there are some drawbacks to their use. Specifically, because of its very nature, garbage begins to emit an unpleasant odor before the bag in which it is stored is even slightly full. Considering it can take several days to fill a trash bag, a simple trash receptacle quickly fills an entire room with noxious odors that are extremely challenging to control. This is especially true if the bag contains food scraps such as fruit and vegetable skins or hulls, meat, seafood or poultry trimmings or similar refuse that naturally deteriorates. While trash bag odors can be found anywhere trash bags are utilized, these odors are particularly prevalent in outdoor trash cans and kitchen trash cans. Considering the foul smell emitted by garbage when stored in a trash bag, it is little wonder that the simple act of throwing away garbage is a completely unpleasant endeavor.

The prior art has put forth several designs for trash bags. Among these are:

US Patent Publication 2006/0262998 to Marie Horak describes a heavy thick plastic trash bag that is opened and closed by means of a plastic zipper. The zippered trash bags come in various sizes and scents. When the zipper is opened a pleasant scent is released. The Zipper Trash Bag keeps unpleasant odors locked inside. Due to a lack of food odors which attract rodents, dogs or other pests that tend to invade your tied garbage sacks, outside garbage will sit undisturbed until pickup time. The zippered trash bag assists communities in keeping their curbs and streets clean. With the zipper concept, the air surrounding the bag is odor free whether the bag is in the kitchen, in the dumpster, or on the curb.

US Patent Publication 2004/0134923 to Melissa Aquino, I-Chun Chiao and Chandrika Kasturi describes a bag or flexible container for use in the disposal of food scraps and wastes. The container is composed of liquid impervious walls with inner and outer surfaces. An absorbent material placed inside the container has an effective amount of an odor neutralizing composition deposited upon it. Preferably the absorbent material is attached to the inner surfaces of the container walls. This container comprises a means for closing and sealing itself. The walls of the container are constructed from a thin flexible plastic.

U.S. Pat. No. 6,199,803 to Thomas C. Schafer describes a trash container system, particularly for marine pleasure craft, for disposing of refuse. The trash container system comprises a trash bag holding device having laterally projecting extensions and a trash receptacle having a resilient, elastomeric inlet mouth at its top. The inlet mouth is coupled to the trash bag holding device about and over the lateral extensions. A sealable zippered refuse expelling outlet is located on the bottom of the container. The resilient elastomeric inlet mouth functions to securely couple the trash receptacle to the trash bag holding device, hold refuse within the trash receptacle, and expand easily and effortlessly in a myriad of dimensions and shapes to receive refuse there through. The body of the trash receptacle is made of mesh material with a zipper extending across its bottom to selectively discharge the contained trash. The trash bag holding device is secured by screws or other like mechanical fasteners or adhesive to a vertical surface such as a wooden cabinet wall.

None of these prior art references describe the present invention.

### SUMMARY OF THE INVENTION

It is an object of the present invention to provide a particularly constructed trash bag that contains a plastic, zipper style closure which seals the bag closed during use and effectively keep odors within the bag.

The present invention is a trash bag apparatus for holding a variety of trash and refuse material. The trash bag apparatus comprises a trash bag having an open top end and a closed bottom end. A zipper slide closure is mounted to the open top end of the trash bag with the zipper slide closure moveable across the open top end of the trash bag to releasably seal the top end closed in a leak free manner. Upon closing the zipper slide closure, the trash bag inhibits odors, liquid, and other material from escaping the trash bag thus ensuring a pleasant, odor free environment.

In addition, the present invention includes a method for holding a variety of trash and refuse material. The method comprises providing a trash bag having an open top end and a closed bottom end, mounting a zipper slide closure to the open top end of the trash bag, moving the zipper slide closure across the open top end of the trash bag, releasably sealing the top end of the trash bag closed in a leak free manner, and inhibiting odors, liquid, and other material from escaping the trash bag thus ensuring a pleasant, odor free environment.

The present invention further includes a trash bag apparatus for holding a variety of trash and refuse material. The trash bag apparatus comprises a first sheet having a first edge, a second edge, a bottom edge, and a top edge and a second sheet having a first edge, a second edge, a bottom edge, and a top edge. The first edge of the first sheet is secured to the first edge of the second sheet and the second edge of the first sheet is secured to the second edge of the second sheet. A zipper slide closure is mounted to the top edge of the first sheet and the top edge of the second sheet with the zipper slide closure moveable across the top edges to releasably seal the top edges closed in a leak free manner. A first handle is secured to the first sheet adjacent the top edge of the first sheet with at least a portion of the first handle extending above the top edge of the first sheet. A second handle is secured to the second sheet adjacent the top edge of the second sheet with at least a portion of the second handle extending above the top edge of the second sheet. Upon closing the zipper slide closure, the trash bag inhibits odors, liquid, and other material from escaping the trash bag thus ensuring a pleasant, odor free environment.

### BRIEF DESCRIPTION OF THE DRAWINGS

FIG. 1 is a perspective view of a trash bag apparatus, constructed in accordance with the present invention, showing a sturdy trash bag with easy grip handles and a zippered top in an opened position ready for trash to be inserted within the plastic trash bag.

FIG. 2 is a perspective view illustrating the trash bag apparatus, constructed in accordance with the present invention, showing the sturdy trash bag with the easy grip handles and the zippered top in a closed position to prevent odors inside the plastic trash bag from escaping.

FIG. 3 is a perspective view illustrating the trash bag apparatus, constructed in accordance with the present invention, showing the sturdy trash bag with the easy grip handles and a zippered top in a closed position to prevent odors inside the plastic trash bag from escaping.

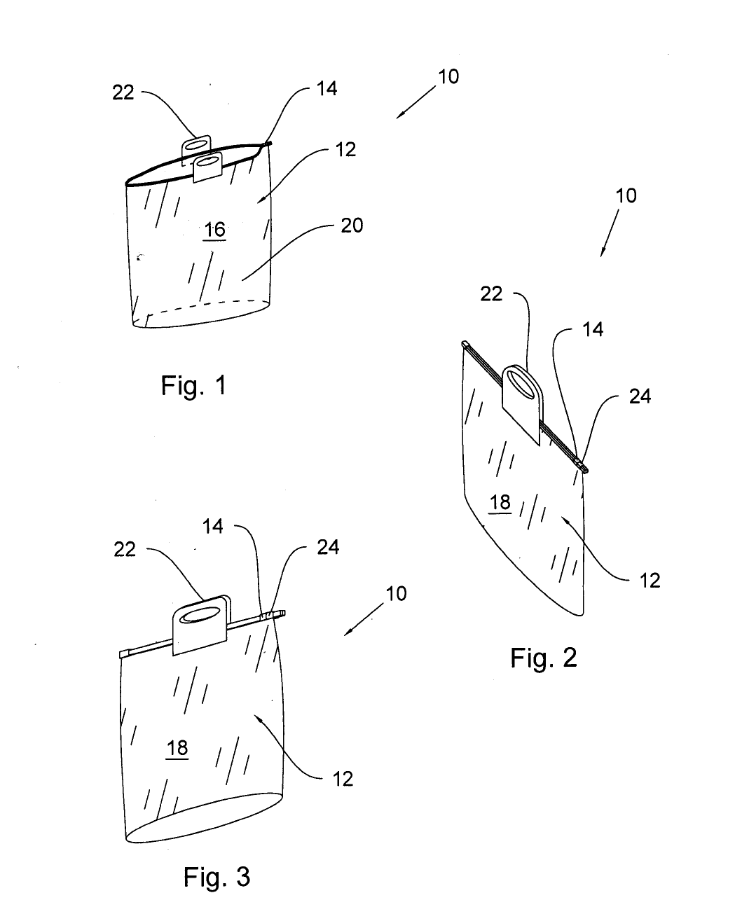

### DETAILED DESCRIPTION OF THE INVENTION

The present invention, hereinafter referred to as a Trash Bag Apparatus, indicated generally at 10, is a particularly constructed trash bag 12 that contains a plastic, zipper slide closure 14 along a top edge of the trash bag 14. The zipper slide closure 14 seals the trash bag 12 closed during use and effectively keep odors, liquids, and other material within the bag. The trash bag 12 of the Trash Bag Apparatus 10 inhibits odors, liquid, and other material from escaping the trash bag 12 when stored outside or within a trash can, thus ensuring a pleasant, odor free environment.

The trash bag 12 of the Trash Bag Apparatus 10 of the present invention has a first sheet 16 having a first edge, a second edge, a bottom edge, and a top edge and a second sheet 18 having a first edge, a second edge, a bottom edge, and a top edge. The first sheet 16 and the second sheet 18 of the trash bag 12 are preferably constructed from a heavy duty, multi ply, plastic material although constructing the first sheet 16 and the second sheet 18 of the trash bag 12 from other waterproof, leak proof materials is within the scope of the present invention.

The first sheet 16 of the trash bag 12 of the Trash Bag Apparatus 10 of the present invention is secured to the second sheet 18 of the trash bag 12 along three edges with an open mouth formed along the top edges. In this manner, the first edge of the first sheet 16 is secured to the first edge of the second sheet 18 and the second edge of the first sheet 16 is secured to the second edge of the second sheet 18. In an embodiment of the present invention, the bottom edge of the first sheet 16 is secured to the bottom edge of the second sheet 18 in the same manner as the other edges.

In another embodiment of the Trash Bag Apparatus 10 of the present invention, the trash bag 12 includes a third sheet 20 having an outer edge. The outer edge of the third sheet 20 is secured between the bottom edge of the first sheet 16 and the bottom edge of the second sheet 18 with the third sheet 20 substantially perpendicular to the first sheet 16 and the second sheet 18. The positioning of the third sheet 20 as described and illustrated herein allows the trash bag 12 to stand in an upright position. The third sheet 20 can further include a fold or pleat allowing the trash bag 12 to be folded flat, when,not in user.

All the edges of the trash bag 12 of the Trash Bag Apparatus 10 of the present invention are secured together with a waterproof, leak proof seal thereby inhibiting odors, liquid, and other material from escaping the trash bag 12. One type of sealing manner within the scope of the present invention is ultrasonic welding of the edges although types of waterproof, leak proof seals can be used.

The top edge of the first sheet 16 and the top edge of the second sheet 18 of the trash bag 12 of the Trash Bag Apparatus 10 of the present invention are free from a permanent seal creating the mouth capable of an opened position ready for trash to be inserted within the plastic trash bag 12. Incorporated into and positioned on the top edges of the first sheet 16 and the second sheet 18, directly above the mouth of the trash bag 12, are a pair of easy grip handles 22 for use in effortlessly lifting a filled trash bag 12 out of the trash can. Incorporated into and positioned directly below the easy grip handles 22 is the sturdy zipper slide closure 14. The zipper slide closure 14 runs the entire length of the top edges of the first sheet 16 and the second sheet 18 and seals the trash bag 12 releasably securely closed during use, preventing noxious odors from escaping the trash bag 12. To facilitate ease of use, a pull tab fastener 24 attached to the zipper slide closure 14 enables the user to easily open and close the trash bag 12. Preferably, the zipper slide closure 14 is constructed from a plastic material although constructing the zipper slide closure 14 from other materials is within the scope of the present invention.

The trash bag 12 of the Trash Bag Apparatus 10 of the present invention is produced in a range of sizes to accommodate small waste paper baskets, standard size kitchen trash cans, large outer trash cans, and oversized industrial bins. A standard large, outdoor version of the trash bag 12 of the Trash Bag Apparatus 10 measures approximately thirty three (33″) inches in length, approximately thirty (30″) inches in width, and approximately thirty (30″) inches in usable depth. Furthermore, the trash bag 12 is preferably manufactured in colors of standard white, gray, or black hues along with any desired color.

Using the Trash Bag Apparatus 10 of the present invention is very simple and straight forward. A user purchases a package of trash bags 12 according to size and personal need. A standard large size trash bag is utilized in an outdoor garbage can. A tall trash bag is appropriate for use in a kitchen trash can. Opening the trash bag 12, the user drops the trash bag 12 the garbage can, spreading the trash bag 12 so that the trash bag 12 encompasses the side walls of the trash can. Thus installed, the trash bag 12 is utilized as a handy storage receptacle for garbage. Each time the user tosses trash into the trash bag 12, they seal the trash bag 12 closed by means of the zipper slide closure 14 on the top edges of the first sheet 16 and the second sheet 18. The user simply moves the zipper slide closure 14 in the opposite direction to open the trash bag 12 and add more garbage to the receptacle. When the trash bag 12 is filled to capacity, the user lifts the trash bag 12 from the trash receptacle by means of the integrated easy grip handles 22 and replaces the full trash bag 12 with a fresh empty trash bag 12.

With its integrated zipper slide closure 14 which seals the trash bag 12 closed during use, the Trash Bag Apparatus 10 of the present invention effectively traps noxious odors, liquids, and other materials within the trash bag 12, preventing them from escaping and infiltrating the atmosphere. Sparing the user the unpleasant stench of garbage that quickly occurs as garbage deteriorates within the trash bag 12, use of the trash bag 12 results in a more pleasant home or business environment. Because of being securely sealed, the trash bag 12 safely contains garbage within the trash bag 12 at all times, preventing fluids and other refuse from leaking from the top of the trash bag 12 and into the garbage can itself. Highly functional for home use, professional cleaning services, businesses, restaurants and office establishments, the trash bag 12 of the Trash Bag Apparatus 10 is well suited for use in kitchens, bathrooms, offices and garages.

Although this Invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claim.

1. A trash bag apparatus for holding a variety of trash and refuse material, the trash bag apparatus comprising:
a trash bag having an open top end and a closed bottom end; and
a zipper slide closure mounted to the open top end of the trash bag, the zipper slide closure moveable across the open top end of the trash bag to releasably seal the top end closed in a leak free manner;
wherein upon closing the zipper slide closure, the trash bag inhibits odors, liquid, and other material from escaping the trash bag thus ensuring a pleasant, odor free environment.

2. The trash bag apparatus of claim 1 wherein the trash bag comprises:
a first sheet having a first edge, a second edge, a bottom edge, and a top edge; and
a second sheet having a first edge, a second edge, a bottom edge, and a top edge;
wherein the first edge of the first sheet is secured to the first edge of the second sheet and the second edge of the first sheet is secured to the second edge of the second sheet.

3. The trash bag apparatus of claim 2 wherein the bottom edge of the first sheet is secured to the bottom edge of the second sheet.

4. The trash bag apparatus of claim 3 wherein each of the edges are secured with a waterproof, leak proof seal.

5. The trash bag apparatus of claim 2 and further comprising:
a third sheet having an outer edge;
wherein the outer edge of the third sheet is secured between the bottom edge of the first sheet and the bottom edge of the second sheet.

6. The trash bag apparatus of claim 5 wherein the third sheet is substantially perpendicular to the first sheet and the second sheet allowing the trash bag to stand in an upright position.

7. The trash bag apparatus of claim 5 wherein the third sheet has a fold allowing the trash bag to lie flat.

8. The trash bag apparatus of claim 5 wherein each of the edges are secured with a waterproof, leak proof seal.

9. The trash bag apparatus of claim 2 and further comprising:
a first handle secured to the first sheet adjacent the top edge of the first sheet, at least a portion of the first handle extending above the top edge of the first sheet; and
a second handle secured to the second sheet adjacent the top edge of the second sheet, at least a portion of the second handle extending above the top edge of the second sheet.

10. The trash bag apparatus of claim 9 wherein the zipper slide closure is positioned directly below a top edge of the first handle and a top edge of the second handle.

11. The trash bag apparatus of claim 1 wherein the zipper slide closure runs the entire length of the open end of the trash bag.

12. The trash bag apparatus of claim 1 and further comprising:
a pull tab fastener attached to the zipper slide closure.

13. A method for holding a variety of trash and refuse material, the method comprising:
providing a trash bag having an open top end and a closed bottom end;
mounting a zipper slide closure to the open top end of the trash bag;
moving the zipper slide closure across the open top end of the trash bag;
releasably sealing the top end of the trash bag closed in a leak free manner; and
inhibiting odors, liquid, and other material from escaping the trash bag thus ensuring a pleasant, odor free environment.

14. A trash bag apparatus for holding a variety of trash and refuse material, the trash bag apparatus comprising:
a first sheet having a first edge, a second edge, a bottom edge, and a top edge;
a second sheet having a first edge, a second edge, a bottom edge, and a top edge, the first edge of the first sheet secured to the first edge of the second sheet, the second edge of the first sheet secured to the second edge of the second sheet;
a zipper slide closure mounted to the top edge of the first sheet and the top edge of the second sheet, the zipper slide closure moveable across the top edges to releasably seal the top edges closed in a leak free manner;
a first handle secured to the first sheet adjacent the top edge of the first sheet, at least a portion of the first handle extending above the top edge of the first sheet; and
a second handle secured to the second sheet adjacent the top edge of the second sheet, at least a portion of the second handle extending above the top edge of the second sheet;
wherein upon closing the zipper slide closure, the trash bag inhibits odors, liquid, and other material from escaping the trash bag thus ensuring a pleasant, odor free environment.

15. The trash bag apparatus of claim 14 wherein the bottom edge of the first sheet is secured to the bottom edge of the second sheet.

16. The trash bag apparatus of claim 15 wherein each of the edges are secured with a waterproof, leak proof seal.

17. The trash bag apparatus of claim 14 and further comprising:
a third sheet having an outer edge;
wherein the outer edge of the third sheet is secured between the bottom edge of the first sheet and the bottom edge of the second sheet.

18. The trash bag apparatus of claim 17 wherein the third sheet is substantially perpendicular to the first sheet and the second sheet allowing the trash bag to stand in an upright position.

19. The trash bag apparatus of claim 18 wherein each of the edges are secured with a waterproof, leak proof seal.

20. The trash bag apparatus of claim 14 wherein the zipper slide closure runs the entire length of the top edges of the first sheet and the second sheet.
